(19) United States
(12) Patent Application Publication
(10) Pub. No.: US 2011/0178817 A1
(43) Pub. Date: Jul. 21, 2011

(54) TARGETED AND PATIENT-FRIENDLY BILLIING SYSTEM METHOD

(75) Inventors: Jeffry P. Porter, Kildeer, IL (US); Paul Hoffman, Manhattan Beach, CA (US); Joseph Karl, St. Louis, MO (US); John Talaga, Chicago, IL (US)

(73) Assignee: McKesson Technologies Inc.

(21) Appl. No.: 13/075,688

(22) Filed: Mar. 30, 2011

Related U.S. Application Data
(62) Division of application No. 10/461,783, filed on Jun. 13, 2003.
(60) Provisional application No. 60/389,236, filed on Jun. 14, 2002.

(51) Int. Cl. G06Q 50/00; G06Q 10/00

(52) U.S. Cl. 705/2

(57) ABSTRACT

A system and method for automatically generating customized and user-friendly patient billing statements which can contain news tailored to the demographics of the recipient based on data mined from the data print stream for the individuals or entities to be billed. In particular, a patient billing system and method that provides a customized solution that transforms ordinary patient billing data into targeted, patient-friendly, data-driven documents that are individualized to each type of patient and which include financial and wellness information.

### CROSS-REFERENCE TO RELATED APPLICATIONS

This application is a divisional of U.S. application Ser. No. 10/461,783, filed Jun. 13, 2003, which is hereby incorporated herein in its entirety by reference.

### FIELD OF THE INVENTION

The present invention relates to a computerized billing system and method, and in particular, a patient billing system and method that provides a customized solution that transforms ordinary patient billing data into targeted, patient-friendly, data-driven documents that are individualized to each type of patient and which include financial and wellness information.

### BACKGROUND OF THE INVENTION

Billing statements play an important part in the Healthcare industry as they provide the medium in which healthcare providers may recover payments for the services rendered. Despite the trend in the Healthcare industry to provide more financial information to their patients, many healthcare providers are saddled with inflexible billing systems that can only generate static, “canned” patient billing documents that are often confusing to the patient and cannot be tailored to the particular needs or interests of the patient. For example, conventional billing statements do not take into consideration the ability of the individual to read the billing statement (e.g., if the person has poor eyesight or only reads Spanish). Furthermore, the conventional billing statements often contain complex and/or confusing medical terminology relating to the services rendered. Accordingly, patients are often unable to read and understand all of the information on the billing statement.

Another issue that often arises is due to the various insurance possibilities that a patient may have. For example, many of the patients who have Medicare are unaware of their own financial responsibilities under the plan. Also, in a situation where a patient has supplemental or secondary insurance, it is often difficult to track the individual requirements of the separate insurance programs and the extent that the particular procedures are covered.

Therefore, there is a need to produce and offer a patient-friendly billing system and method that provides a simplified billing statement that may be particularly tailored according to the needs and health issues of a patient, while being easy and economical to manufacture and use.

### SUMMARY OF THE INVENTION

The present invention is an improvement over conventional patient billing systems in that the system and method for providing a simplified billing statement that may be tailored according to the particular needs of a patient is unique and an improvement over the prior art. In particular, the present invention enables the use of particular patient data (e.g., information pertaining to the patient's financial class or demographics) to customize the printed format and text for each patient. In operation, the software and document publishing system of the present invention can extract insights about the patient from the patient data so as to tailor the billing statement depending upon the particular insurance coverage, if any, of the patient. The system may then specifically tailor the billing statement to that patient. For example, billing for a Medicare patient may include custom-tailored Medicare information and font styles of an increased size that are easier to read. Furthermore, the billing statement may include targeted marketing and educational information based on the patient information.

The system of the present invention also allows data from multiple accounts to be combined and presented as a single bill with one balance for the patient to pay or merged into the same envelope for postage and operational savings. Data from multiple billing systems of multiple healthcare providers may also be merged into a combined bill and presented to the patient as a single balance. The formats can be tailored to meet the needs of the provider as well.

It is therefore an object of the present invention to provide a new and improved patient-friendly billing system and method for producing patient-friendly billing statements that are easy and straightforward to read and understand.

It is another object of the present invention to utilize patient data to customize patient-friendly billing statements for each patient.

It is yet another object of the present invention to automatically provide custom-tailored insurance information to patients based on the information stored in the system.

It is still yet another object of the present invention to use patient data from the system to direct targeted marketing and educational information to patients.

Yet another object of the present invention is to interpret the patient data in order, if required, to perform such operations as: printing special text; suppressing itemized charges; printing marketing/wellness news; renaming medical technology into patient-friendly terminology; and providing specialized billing formats.

The present invention provides a targeted and patient-friendly computerized billing system, so that the problems of conventional billing systems can be overcome and the foregoing objects provided.

Other objects, features and advantages of the invention will be apparent from the following detailed disclosure, taken in conjunction with the accompanying sheets of drawings, wherein like reference numerals refer to like parts.

### BRIEF DESCRIPTION OF THE DRAWINGS

Having thus described the invention in general terms, reference will now be made to the accompanying drawings, which are not necessarily drawn to scale, and wherein:

FIG. 1. is a block diagram illustrating an embodiment of the invention showing a server operably connected to computers (not shown) via modems or the Internet and to a disk array.

FIG. 2 is an example of a conventional prior art billing statement.

FIGS. 3A and 3B are an example of a data sheet used in one embodiment of the present invention.

FIGS. 4A and 4B are an example of one embodiment of a targeted and patient-friendly billing statement of the present invention that is created based on the information from the data sheet from FIGS. 3A and 3B.

FIG. 5 is another example of an embodiment of a targeted and patient-friendly billing statement of the present invention.

FIGS. 6A and 6B are yet another example of a targeted and patient-friendly billing statement of the present invention including promotional material about the provider.

FIG. 7 is still yet another embodiment of a targeted and patient-friendly billing statement of the present invention.

FIGS. 8A and 8B is another embodiment of a patient-friendly billing statement of the present invention.

FIGS. 9A and 9B is an example of a billing statement of the present invention that combines multiple accounts into one statement.

FIG. 10 is a flow chart diagram of one embodiment of the steps involved in producing targeted and patient-friendly billing statements of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

While this invention is susceptible of embodiment in many different forms, there is shown in the drawings and will herein be described in detail several specific embodiments, with the understanding that the present disclosure is to be considered merely an exemplification of the principles of the invention and the application is limited only to the appended claims.

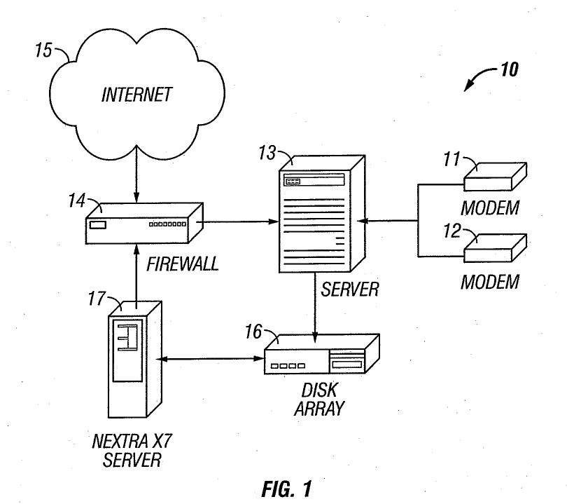

Referring now to the drawings, and particularly to FIG. 1, there is shown a preferred embodiment of the hardware needed for the preferred embodiment of the patient billing system of the present invention. The targeted and patient-friendly billing system, generally designated by the number 10, is shown as having an IBM® or comparable server 13, a disk array 16, and a Sun® Netra XI type server 17.

The IBM Server 13 preferably has Windows 2000 Server software as its operating system and WildCat® Inet Server software to accept files through conventional analog lines using modems 11 and 12. In the preferred embodiment, this system is used as a Bulletin Board System (“BBS”), or an electronic message center that allows one to dial in with a modem, review messages left by others, and leave messages. It is appreciated that the IBM server may use different server software and/or operating systems and not depart from the scope of the present invention.

The Sun® Netra XI type server 17 preferably is installed with: a Sun Solaris 8 operating system; First Logic Ace software to verify and standardize the mailing address; and Adobe Acrobat® 5.0 for Unix® Server so as to enable the creation of PDF files for electronic presentation, research and COLD storage. “COLD” is the acronym for storage of data on optical discs, such as CD-ROMs. Storing large volumes of data on laser disk, as opposed to microfiche or microfilm, lets the user access and search this information by computer.

The Sun Netra XI Server 17 also preferably has installed applications in Korn Shell so as to provide scripts that will accomplish a process by automating the processing and transmission of the data. Applications in ANSI C and C++ will accomplish data mining from the original data stream file and data file(s) provided by the healthcare provider. In addition to the data mining, such C programs will also provide the formatting of the data for the particular print environment to be used. While a Sun Netra XI Server is preferred, it is appreciated that other servers or devices having the same, similar or different software may be utilized and not depart from the scope of the present invention.

The disk array 16 is used to store all received and processed data. While an example of a disk array is a Maxtor Max Attach 4300 hard disk array, it is appreciated that other types of disk arrays or comparable devices may be used and not depart from the scope of the present invention. The disk array 16 preferably keeps a backup of the C and Korn Shell applications. By maintaining all such data and applications in one central location, processing power can be expanded with minimal impact. It is appreciated that software such as, but not limited to, Corel® Draw 10 can be used to create all of the overlays or forms as well as any artwork that may be needed. Using the system of the present invention, print files can be generated in: ANSI print format; Xerox DJDE; Xerox VIPP; PostScript, PCL and PDF.

As shown in FIG. 1, when data arrives via BBS or File Transfer Protocol (FTP) via modems 11 and 12 or otherwise to server 13, the data is systematically moved to the disk array 16 and thereby removed from the IBM server 13. With respect to data arriving via FTP, files are first uploaded from a workstation to an FTP server or downloaded from an FTP server to a workstation. The files are then available on the Internet.

Based on availability, the Nextra XI server 17 will pick the file or files that have arrived, decrypt the file or files, process the data, generate the reports and print the images. An example of a decryption system is PGP, which stands for “Pretty Good Privacy” and is a public domain encryption system that is based on the public key—private key method wherein a public key is disseminated to the intended recipient and a public key is used to decrypt messages that you receive. In order to increase the security of the communications and file transfers, a firewall 14 is preferably provided between servers 13 and 17 and the Internet 15. It is appreciated that other security measures and devices may be used and not depart from the scope of the present invention. While the preferred embodiment is shown as using the Internet or a modem to transmit data, it is appreciated that the system of the proposed invention may comprise a stand alone computer having the necessary software or a networked computer that transmits and shares data through a secure network.

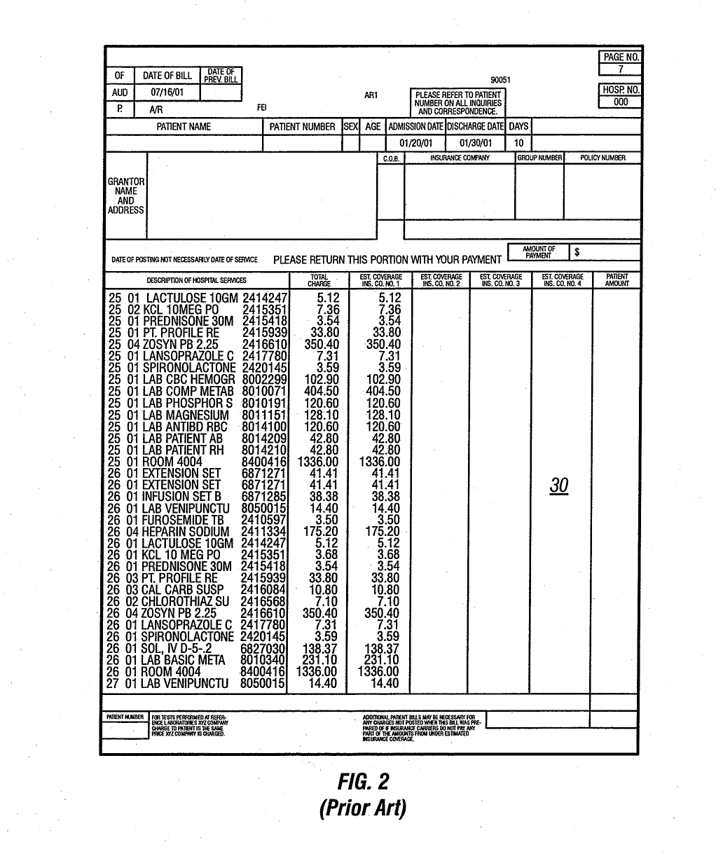

Referring to FIG. 2, a conventional prior art billing statement is displayed. The conventional billing statement, generally designated by the numeral 30, provides a minimum amount of information such as the patient information and a listing of the medical services according to their technical name.

Unlike the conventional billing statements, among the types of custom tailored and user-friendly operations that the system of the present invention can perform in response to information in the data stream about the recipient are: printing special text based on “Financial Class” and “Insurance type”; printing special text based on the existence of no, primary or secondary insurance providers to the patient; suppressing itemized charges of a typical hospital bill based on such criteria as “Patient Type” or “Insurance Type”; printing marketing/wellness news based on the demographic information of the patient; renaming medical terminology into patient friendly terminology; and suppressing the payment stub portion of the bill, if the Patient Balance equals zero.

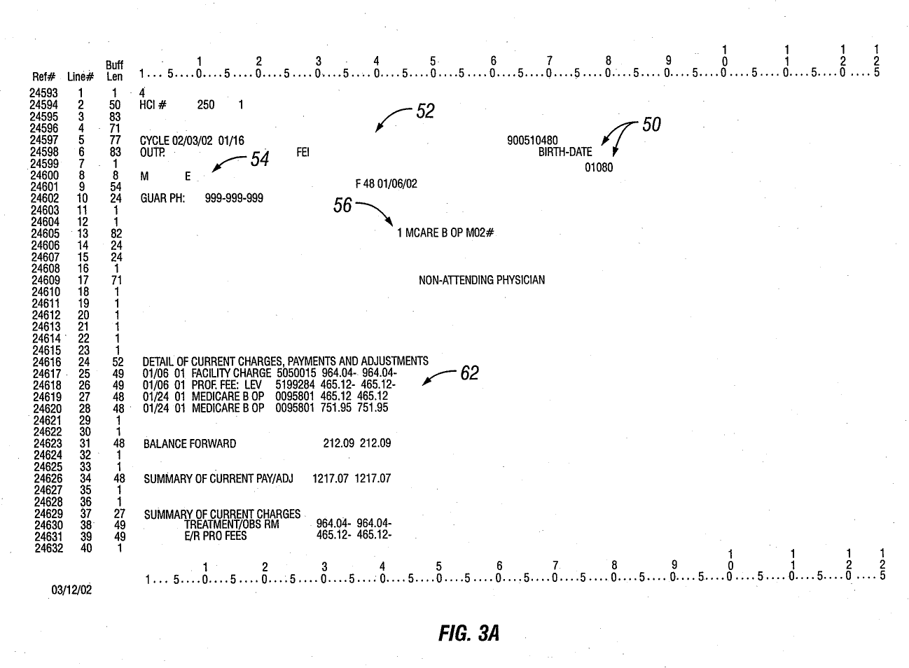

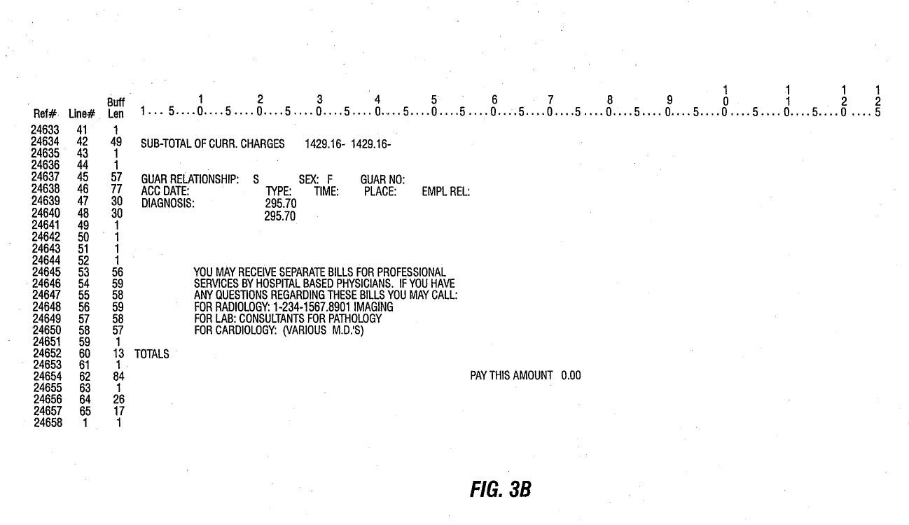

FIGS. 3A and 3B illustrate an example of a data sheet printout of the patient data stream received from the healthcare provider. The data stream generally includes information that is categorized into a plurality of categories. Examples of categories include, but are not limited to: patient information; insurance information; healthcare provider information; current charges, payments and adjustments; message area; and patient balance. While the information is shown as being listed according to particular line numbers, it is appreciated that the information may be listed or categorized in any number of ways and not depart from the scope of the present invention. Furthermore, while a data stream is shown and disclosed, it is appreciated that the information may be inputted and stored in other mediums including, but not limited to, databases that may be accessed by the health care providers.

The patient information may be listed in one or more patient information areas or data fields 50 of the data stream. Referring to the example of the data stream in FIG. 3, the patient information 52 is generally listed in lines 2 through 10 and line 45. Patient information may include, but is not limited to the patient name, address, phone number, date of birth and sex. Additionally, the data stream may also include an area 54 to designate the financial class of the patient. Such information may be used by the insurance company or other entity that issues the billing statement to provide financial or other pertinent information to the patient, including payments plans or alternate means of payment.

The insurance information area 56 preferably includes information pertaining to all of the patient's various insurance coverage. In the preferred embodiment, the insurance information area will list the patient's primary insurance coverage as well as any supplemental or secondary insurance coverage. Examples of insurance coverage include, but are not limited to, insurance policies from insurance companies such as Blue Cross & Blue Shield, Medicare and AARP. Additionally, the insurance information area 56 will indicate if the patient does not have any insurance on file. In operation, the system of the present invention will read the data associated with the insurance information to determine whether the billing statement should include specifically tailored information on the billing statement for the patient, as described in more detail below.

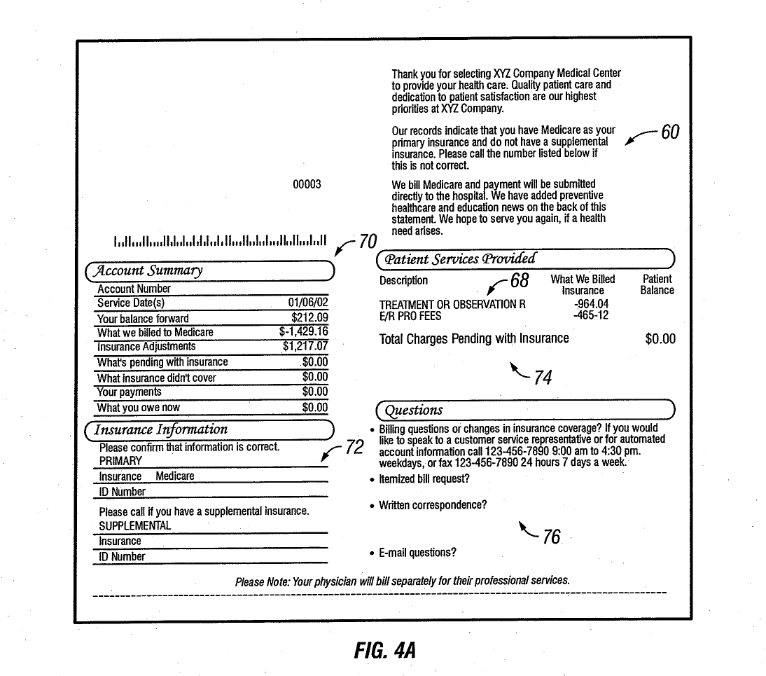

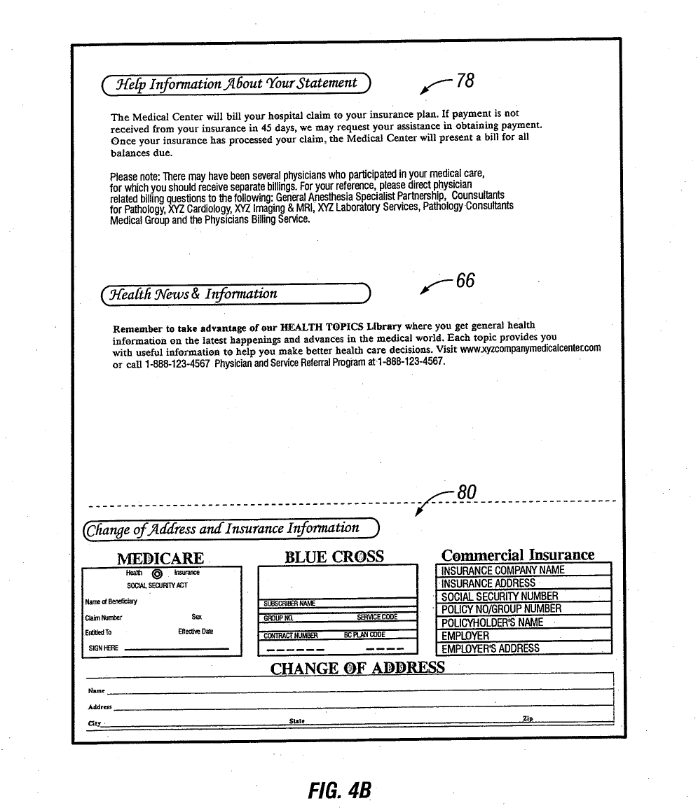

Referring again to FIG. 3A, the data sheet indicates that the patient has Medicare in line 13. As shown by reference number 60 in FIG. 4A, the billing statement may therefore include information concerning the health care provider's billing policies toward patients with Medicare, or any other information concerning Medicare that may be useful to the patient. As shown in area 60 of the billing statement, an example of a possible statement concerning the healthcare provider's Medicare policies is as follows:
We bill Medicare and payment will be submitted directly to the hospital. We have added preventive healthcare and education news on the back of this statement. We hope to serve you again, if a health need arises.

As only Medicare is listed in the insurance information section of the data stream, and no secondary insurance is listed, the system preferably will automatically print language on the billing statement regarding the patient's insurance coverage. Referring to the example of a billing statement in FIG. 4A, an example of language regarding the patient's primary and secondary or supplemental insurance coverage is as follows:
Our records indicate that you have Medicare as your primary Insurance and do not have a supplemental insurance. Please call the number listed below if that is not correct.

Similarly, if the patient is listed as having no insurance (“self-pay”), the billing statement preferably indicates that the health care provider does not have any insurance information on file. The billing statement may accordingly include appropriate language to verify that the patient does not have any insurance. An example of such language is as follows:
Our records indicate that you have no insurance for the services listed below. If this is not correct please call our Account Service Unit immediately.

While the above paragraphs are shown and described, it is appreciated that the paragraphs will vary depending on the type(s) of insurance coverage that the patient has and are only an example of the information that may be included on the billing statement regarding the patient's insurance coverage. Accordingly, the present invention is not limited to the specific embodiments shown in the Figures.

It is also appreciated that the system may tailor the billing statement to be easier to read if the data stream indicates that the patient has Medicare or has other potential problems that might hinder the patient's understanding of the billing statement. For example, the billing statement may be printed in a larger and/or different font that may be more readily read by someone who has poorer vision. Additionally, the billing statement may be printed in a foreign language if the patient information indicates that the patient does not read English.

The Current Charges, Payments and Adjustments section 62 preferably comprises a listing of itemized charges. The listing preferably includes information relating to the date(s) that the various services were provided; the types of services provided; a service code; and the amount of payments and charges. Additional information may include the balance forward; a summary of the current payments and adjustments; and a summary of the current charges. In the preferred embodiment, the system will adjust or tailor the billing statement based on the information provided in the Current Charges, Payments and Adjustments section 62. For example, itemized charges listed in section 62 may be suppressed on the billing statement if the information in the data stream indicates that the “patient type” is “inpatient”. Moreover, if the balance due is zero, then the payment stub portion may be suppressed on the billing statement as shown in FIG. 4A at reference numeral 64.

Reference numeral 66 of FIG. 4B illustrates an example of the type of Health News & Information that may be selected to appear on the statement depending on the patient's demographics or interests. In the preferred embodiment, the system reviews the patient data and demographic information to permit the health care provider to include information that is specifically tailored to the needs and/or health problems of the patient.

In the preferred embodiment, the medical terminology of the summary of current charges is re-named and changed, if necessary, to patient-friendly terminology. For example, the medical terminology of “Facility Charge” and “Prof. Fee: Lev” listed in lines 27 and 28 of FIG. 3A are preferably read by the system and changed into more user-friendly descriptions such as “Treatment or Observation Room” and “E/R Pro (Professional) Fees” as shown in area 68 of the billing statement. Examples of other user friendly descriptions includes, but are not limited to: Operating Room Services; Central Services and Supplies; Imaging; and Pharmacy.

Referring again to FIG. 4A, a simplified and patient-friendly billing statement incorporating the information from the data sheet in FIGS. 3A and 3B is shown. The billing statement is preferably divided into distinct categories having topical headings to facilitate the reading of the information from the billing statement. Examples of categorical sections and topical headings, as shown in FIG. 4A, include an Account Summary section 70; an Insurance Information section 72; a Patient Services Provided sections 74; a Questions section 76; and a Payment Stub section 64. Additionally sections may include a Helpful Information About the Billing Statement section 78; a Health News and Information section 66; and a Change in Address and Insurance Information section 80. Furthermore, information concerning the insurance coverage on file or other pertinent information may also be included at the top of the billing statement or elsewhere. While the example shown in the Figures and described herewithin include the aforementioned categorical sections and topical headings, it is appreciated that the system of the present invention may list the information from the data stream in additional or different sections and headings and not depart from the scope of the present invention. Furthermore, it is appreciated that the information may be organized in any number of ways on the billing statement and not depart from the scope of the present invention.

In operation, the system reads the information from the data stream and incorporates that information, as well as additional information or material based on the data stream information, into the billing statement. Referring again to the example shown in FIGS. 3A, 3B, 4A and 4B, the Account Summary section 70 succinctly details the information from the Current Charges, Payments and Adjustments area 62 from the data stream. In particular, the Account Summary section 70 informs the patient that the date that the services were provided was Jan. 6, 2002; the patient's prior balance was $212.09; the amount that the healthcare provider billed the patient's insurance, Medicare, was $1,429.16; the amount that Medicare paid was $1,217.07; and that the patient does not presently owe any money. Additional information may include, but is not limited to, any amounts that are currently pending with the patient's insurance providers; any amounts that the insurance providers indicate that they will not cover; and any amounts that the healthcare provider is responsible for. Because the patient does not currently owe any money, the system will preferably automatically suppress the patient pay stub 64, thereby reaffirming to the patient that no money is presently owed.

The Insurance Information section 72 preferably lists information pertaining to the patient's primary and supplemental insurance coverage. As shown in the example in FIGS. 3A and 4A, the billing statement reads the insurance information from line 13 of the Insurance Coverage section 56 of the data sheet and lists the primary insurance coverage as Medicare and no supplemental insurance in the Insurance Information section 72. Accordingly, the system may then include information on the billing statement that is specifically tailored to Medicare patients.

The Questions section 76 of the billing statement may include a variety of information pertaining to the healthcare provider and/or the billing statement. Referring to the example of FIG. 4A, the Questions section 76 may include information on how to address any questions or comments that the patient may have concerning the billing statement. The billing statement may also include additional information to clarify the healthcare provider's billing policies and the services that were performed in the Helpful Information section 78.

Additionally, the billing statement may also include health related information such as, but not limited to, seminars and/or literature on various medical topics. In the preferred embodiment, the billing statement reads and interprets the services that were performed on the patient, as well as other patient demographic information, to specifically tailor the health news and information to the patient's needs. For example, if the patient has had bypass surgery, the billing statement may include information on how to control one's cholesterol or how to detect a heart attack, or references pertaining to the same. It also may include information relating to hospital services that relate to the particular health issues that pertain to the patient. For example, it may provide details about possible doctors to contact regarding follow-up care or other marketing information pertaining to the healthcare provider. Additionally, the News and Information section 66 may include information pertaining to the patient's insurance coverage. For example, if the patient is listed as having Medicare, then the News and Information section may include, among other things, information on Medicare's annual deductible, scope of coverage and payment procedures.

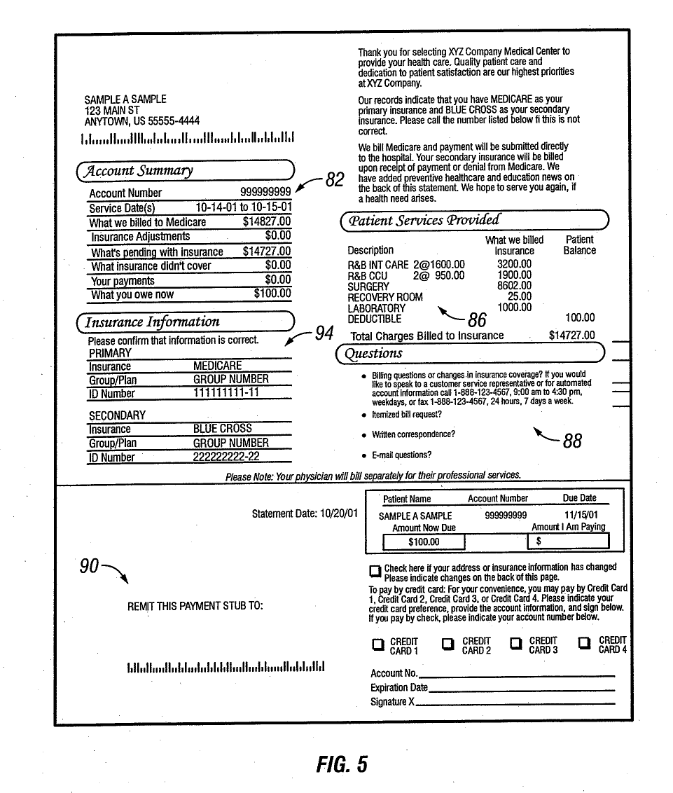

FIG. 5 illustrates another example of a billing statement that may be produced by the system of the present invention. Similar to the example shown in FIG. 4A, the billing statement is preferably divided into distinct categories having topical headings to facilitate the reading of the information from the billing statement. Examples of categorical sections and topical headings include, but are not limited to, an Account Summary section 82; an Insurance Information section 84; a Patient Services Provided sections 86; a Questions section 88; and a Payment Stub section 90. Furthermore, information concerning the insurance coverage on file or other pertinent information may also be included at the top of the billing statement or elsewhere. While the example shown in FIG. 5 and described herewithin includes the aforementioned categorical sections and topical headings, it is appreciated that the system of the present invention may list the information from the data stream or the like in additional or different sections and headings and not depart from the scope of the present invention. Furthermore, it is appreciated that the information may be organized in any number of ways on the billing statement and not depart from the scope of the present invention.

Referring to the Account Summary section 82, the billing statement indicates that all but $100.00 is pending with the patient's insurance. Accordingly, the system automatically includes a pay stub 64 for the patient to remit payment to the healthcare provider. Additionally, the Insurance Information section 84 indicates that the patient has Medicare as its primary insurance provider and Blue Cross as its supplemental or secondary insurance provider.

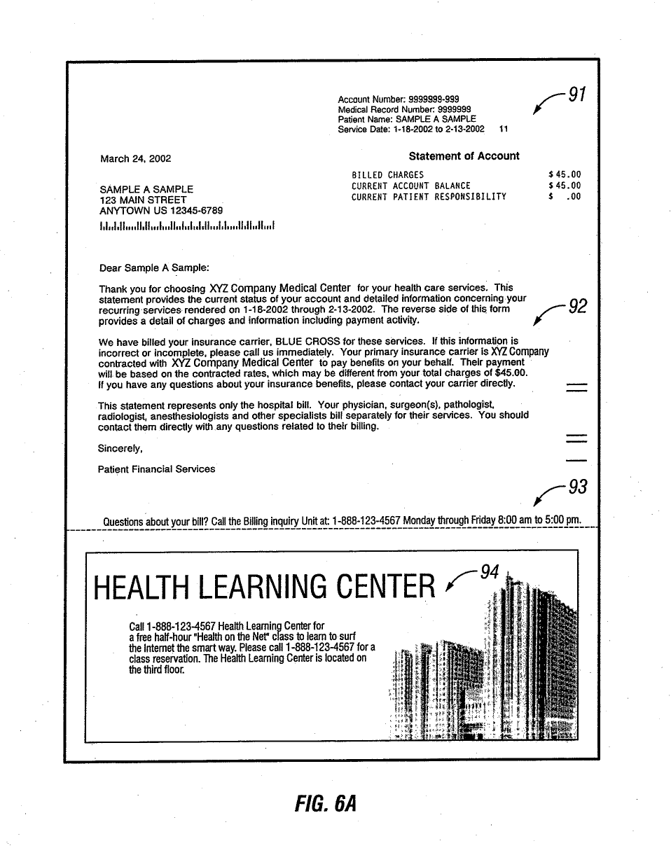

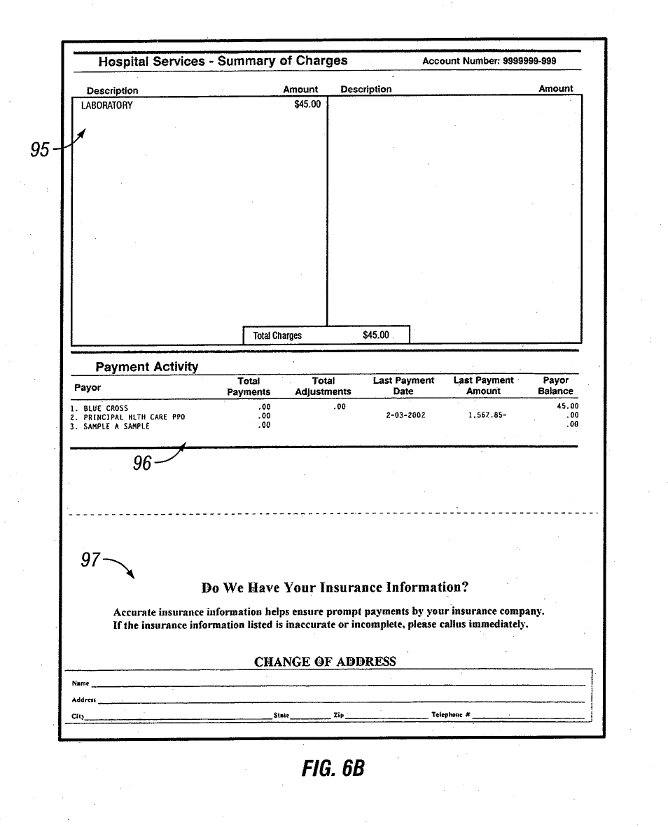

FIGS. 6A and 6B illustrate an alternate embodiment of a patient-friendly billing statement of the present invention. Information read from the data stream, database or the like is used to tailor the billing statement toward the particular patient to make the statement easy to read and understand. In particular, the example shows the billing statement in the form of a modified letter to the patient. The example shown in FIGS. 6A and 6B shows the billing statement divided into an Account Information section 91, a body 92 of the letter, a Contact Information section 93, a News and Information section 94, a Description of the Services and Charges section 95, a Payment Activity section 96 and an Insurance and Patient Information Update section 97. While the examples shown in FIGS. 6A and 6B and elsewhere depict certain categorical sections and topical headings, it is appreciated that the system of the present invention may include different or additional material and list the information in additional or different sections and headings and not depart from the scope of the present invention. Furthermore, it is appreciated that the information may be organized in any number of ways on the billing statement and not depart from the scope of the present invention.

Information contained within the Account Information section 91 preferably includes the patient name and service date, as well as a summary of the account. In this example, the account is shown as having a current account balance of $45.00, with the patient's current responsibility being $0.00. The body 92 of the letter may detail, among other things, the services that were rendered and the fact that the healthcare provider (e.g., a hospital) billed the patient's primary insurance provider (e.g., Blue Cross). Contact information is also preferably clearly provided to allow the patient to contact the health care provider with any questions. It is also appreciated that the system may allow for the healthcare provider to direct messages to the patient. For example, if the account is determined to be substantially past due, the system may automatically include language indicating that the account is past due and will be turned over to a collection agency unless payment is made.

News regarding the healthcare provider or various programs or services may be included in the News and Information section 94. In the preferred embodiment, the system receives and reviews the demographic information concerning the patient to allow it to include news and information that is of particular relevance to the patient.

Referring now to FIG. 6B, the second page (or back side of the first page shown in the example in FIG. 6A) is shown. The Description of the Services and Charges section 95 preferably includes a description of the services provided and the associated charges. In the preferred embodiment, the description reads the specific medical terminology listed in the data stream or the like and converts the information into patient-friendly terminology to render the billing statement more readable by the patient.

The Payment Activity section 96 preferably includes information such as, but not limited to, the amount that the principal insurance provider, supplemental insurance provider and patient have been billed and paid. Additionally, the billing statement may include field entry areas in an Insurance and Patient Information Update section 97 to allow the patient to fill out, update and/or correct information relating to the patient or the patient's insurance.

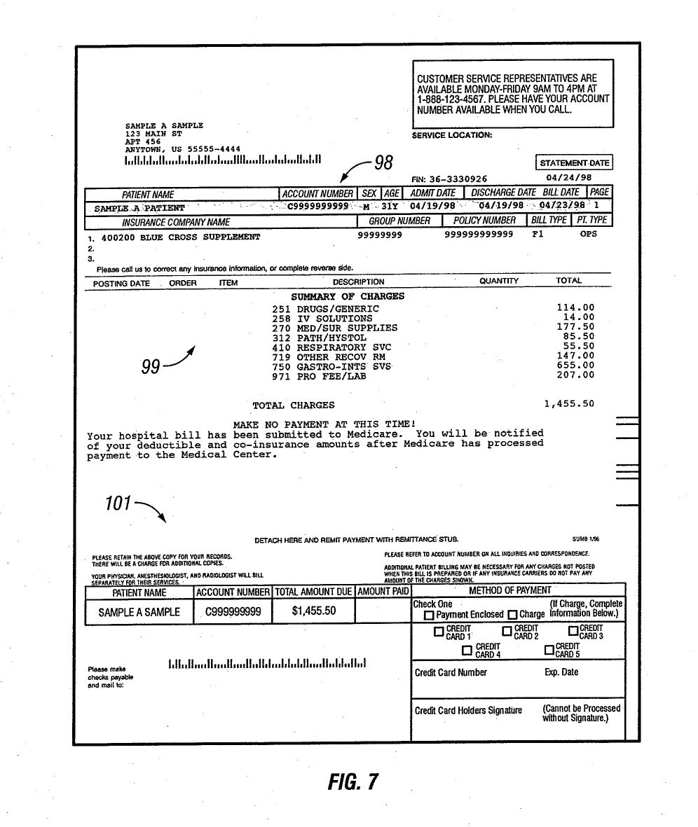

FIG. 7 is yet another embodiment of a patient-friendly billing statement of the present invention. The billing statement includes information 98 pertaining to the patient and the insurance companies near the top of the statement; a description of services performed and the associated charges 99 in the middle of the statement; and a payment stub 101 at the bottom. In the present example, the patient information indicates that the patient has Medicare as his or her primary insurance provider and Blue Cross as a supplemental insurance provider. As the healthcare provider is billing Medicare for the full extent of the bill, the statement preferably clearly states that the patient is not currently responsible for the bill and should not remit any payments. Alternatively or additionally, the payment stub may be omitted when the patient is not currently responsible for payment. While the example shown in FIG. 7 and described here above includes the aforementioned information, it is appreciated that the system may include different or additional material on the billing statement. Furthermore, it is appreciated that the information may be organized in any number of ways on the billing statement and not depart from the scope of the present invention.

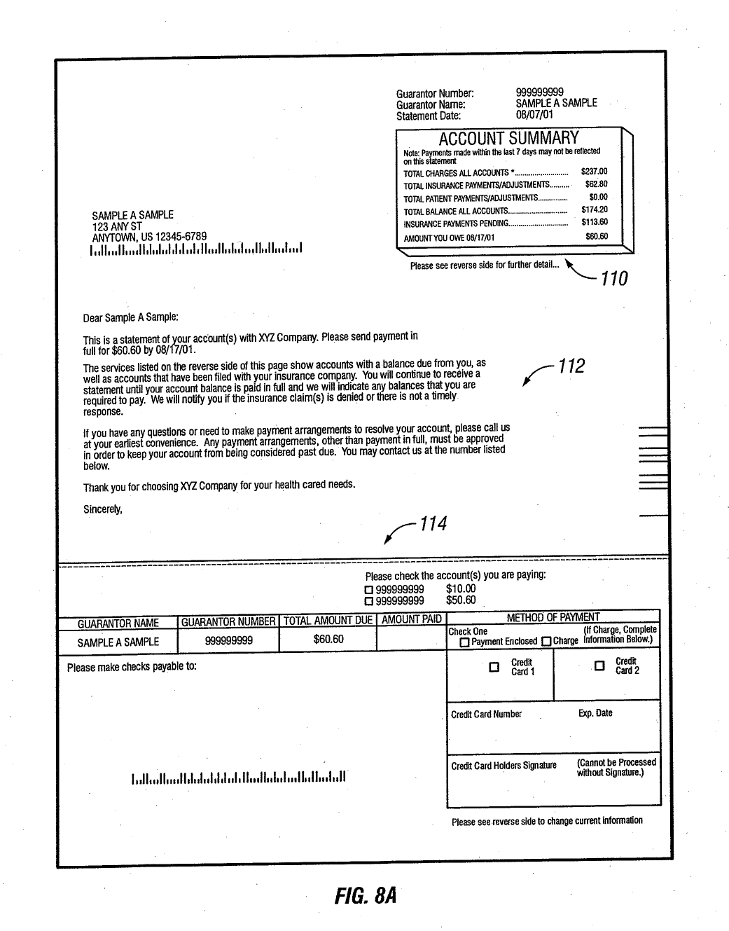

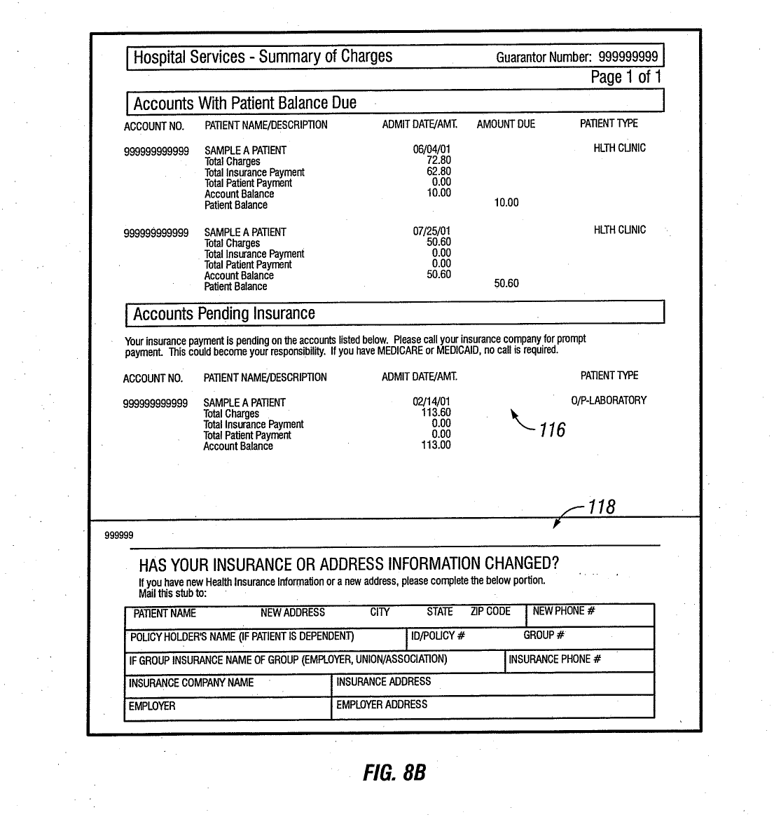

Referring to FIGS. 8A and 8B, is yet another example of a billing statement. The example shown in FIGS. 8A and 8B shows the billing statement divided into the Account Summary section 110, a body 112 of a letter, a Payment Stub section 114, a Summary of Charges section 116 and an Insurance and Patient Information Update section 118. It is appreciated that the system of the present invention may include different or additional material and list the information in additional or different sections and headings and not depart from the scope of the present invention. Furthermore, it is appreciated that the information may be organized in any number of ways on the billing statement and not depart from the scope of the present invention.

The Account Summary section 110 preferably includes a brief synopsis of the charges pertaining to a particular account. Examples of items that may be listed in the Account Summary section include, but are not limited to: total charges for the account(s); total insurance payments/adjustments that have been made; total patient payments/adjustments that have been made; total balance on the account(s); insurance payment pending; and the amount the patient currently owes. The specific information on the charges is preferably listed in the Summary of Charges section 116. While the Summary of Charges section lists the charges according to the date the service was performed, it is appreciated that the charges may be categorized in any number of ways and not depart from the scope of the present invention. The Summary of Charges section 116 may also include information regarding the charges that are currently pending before the insurance company. If the charges have been pending for a certain amount of time, the system may be programmed to automatically include a notice to the patient that unless the insurance (except Medicare) pays the amount, the patient will be individually responsible for the charges.

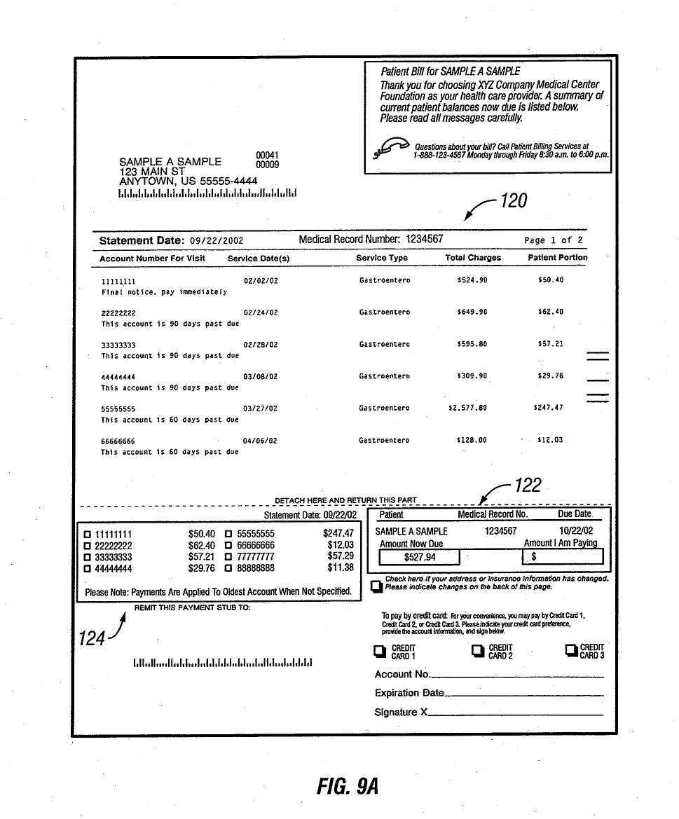

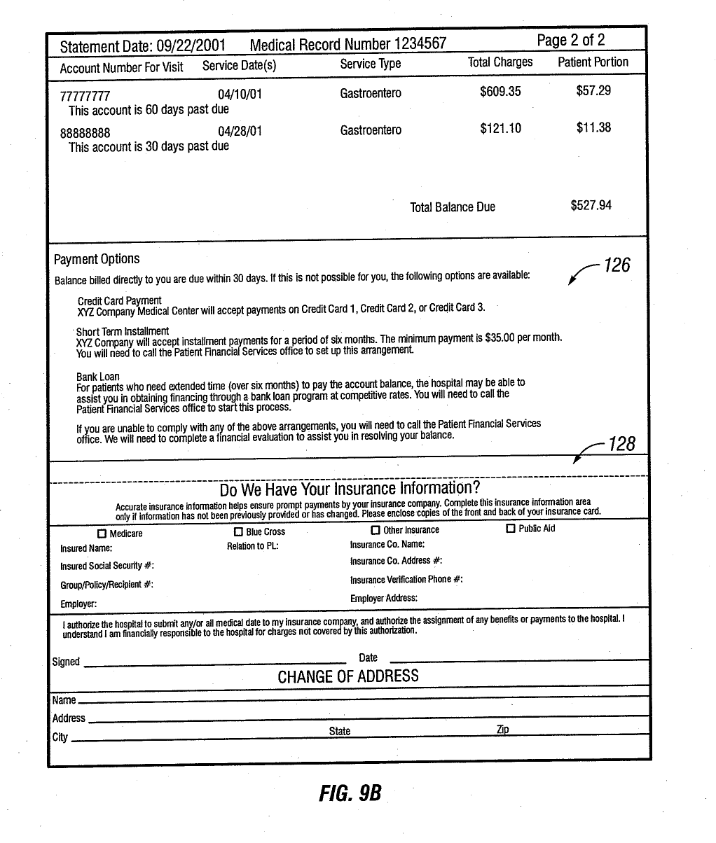

FIGS. 9A and 9B illustrate one embodiment of a billing statement produced by the system of the present invention that combines information from multiple accounts of the patient into one statement. The example shown in FIGS. 9A and 9B shows the billing statement divided into the Summary of Charges section 120, a Payment Stub section 122, an Information and News section 126, and an Insurance and Patient Information Update section 128. It is appreciated that the system of the present invention may include different or additional material and list the information in additional or different sections and headings and not depart from the scope of the present invention. Furthermore, it is appreciated that the information may be organized in any number of ways on the billing statement and not depart from the scope of the present invention.

The Summary of Charges section 120 may include charges for the same patient under multiple accounts, thereby simplifying the billing procedure for both the healthcare provider and patient. The Payment Stub section 122 preferably includes an Account Charges Summary 124 section to allow the patient to indicate which of the accounts any remitted payments should be applied to. Although information concerning the various payment options is shown in the Information and News section, it is appreciated that any other type of news or information pertaining to the healthcare provider, bill or otherwise, may be included and not depart from the scope of the present invention. It is further appreciated that the system may provide for multiple billing statements pertaining to the various accounts of a patient to be merged into a single envelope. Data from multiple billing systems of multiple healthcare providers may also be merged into a combined bill and presented to the patient as a single balance.

It is appreciated that the system may automatically, or upon the health care provider's request, send a billing statement in the form of a confirmation letter to the patient detailing the patient's insurance information on record and informing the patient that the health care provider has billed the patient's insurance provider. For example, if the system determines that the patient is not presently responsible for the charges and the health care provider has billed the insurance provider (e.g., Medicare), the system may automatically create an insurance confirmation letter for the health care provider to send to the patient. The letter may contain information pertaining to the patient's insurance coverage as well as the health care provider's billing policies. It is appreciated that the system of the present invention may include material in a number of different formats and list the information in different sections and headings and not depart from the scope of the present invention. Furthermore, it is appreciated that the information may be organized in any number of ways on the confirmation letter and not depart from the scope of the present invention.

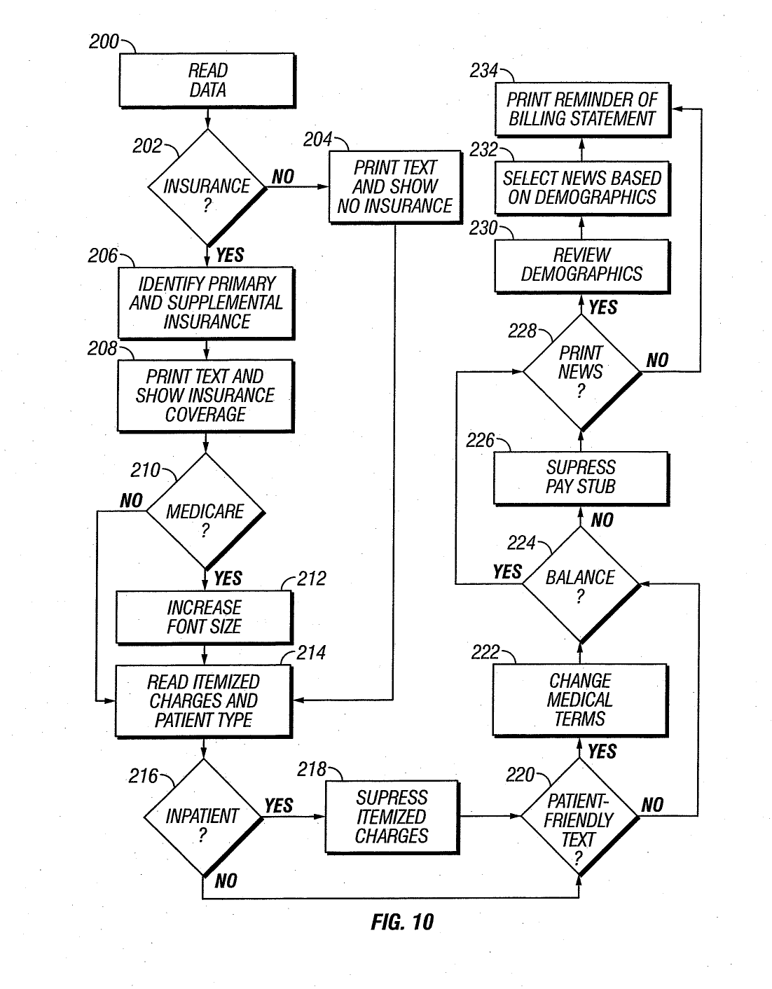

Referring to FIG. 10, the preferred steps in creating a targeted and patient-friendly billing statement are shown. While the operations of the present invention to be described in connection with the flow diagram of FIG. 10 comprise one example of the manner in which the operations can take place, other sequences should be deemed as being within the scope of the present invention.

In order to create a billing statement, the system receives and reads the data from the data stream, database or the like in step 200. In reading the information contained in the data stream, the system will determine whether the patient has any insurance in step 202. If it determined that the patient does not have any insurance on file in step 202, then the system will print text on the billing statement in step 204 indicating that the patient does not have any insurance on file and that he or she will be responsible for the bill. The system may then proceed to read the itemized charges and patient type in step 214 as described below.

If, on the other hand, the system determines from reading the information contained in the data stream that the patient has insurance in step 202, then the system will identify the primary and supplemental insurance from reading the information from the respective data fields from the data stream in step 206. Once the primary and supplemental insurance is identified, the system in step 208 preferably will specifically tailor the billing statement by, among other things, including information relating to the particular insurance coverage of the patient, and/or by formatting the billing statement for the patient. In particular, the system will check to determine whether the patient is a Medicare patient in step 210. If it is determined that the patient is a Medicare patient then the font size for the billing statement may be increased and custom Medicare text may be printed on the billing statement in step 212.

Once the insurance coverage is determined, the itemized charges and patient type are read in step 214. If the information read from the data stream indicates that the patient type is an “inpatient” in step 216, then the system will preferably suppress the itemized charges in step 218. If patient friendly text is desired for that particular type of patient in step 220, then the medical terms may be automatically simplified in step 222 to make the statement more understandable to the patient. The system will also read the information from the data stream in step 224 to determine whether the patient owes any money. If the patient does not owe any money, or has a zero balance, the system preferably automatically suppresses the pay stub portion of the billing statement in step 226. If news is to be printed on the billing statement in step 228, the demographics of the patient are preferably reviewed in step 230. By including news and other information based on the demographic information of the patient in step 232, the system therefore allows the healthcare provider to provide more relevant information and marketing information to consumers. The system will thereafter create the remainder of the statement in step 234.

It will be understood that modifications and variations may be effected without departing from the scope of the novel concepts of the present invention, but it is understood that this application is limited only by the scope of the appended claims.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A method of preparing a customized billing statement regarding services performed by a healthcare provider, the method comprising:
determining billing data from a plurality of accounts of a single patient; and
generating, by a processor, a consolidated billing statement comprising the determined billing data from each of the plurality of accounts.

2. A method according to claim 1, wherein generating the consolidated billing statement comprises generating a consolidated billing statement comprising an itemization of each of the plurality of accounts and a respective outstanding charge for each of the plurality of accounts.

3. A method according to claim 2, wherein generating the consolidated billing statement comprises generating a consolidated billing statement comprising a payment stub section enabling a designation of at least one account from the plurality of accounts to which a remitted payment is to be applied.

4. A method according to claim 1, wherein generating the consolidated billing statement comprises generating a consolidated billing statement comprising a single balance determined by merging outstanding charges for each of the plurality of accounts.

5. A method according to claim 1, wherein two or more of the plurality of accounts are each associated with a respective unique visit of the patient.

6. A method according to claim 1, wherein two or more of the plurality of accounts are each associated with a respective unique healthcare provider.

7. An apparatus for preparing a customized billing statement regarding services performed by a healthcare provider, the apparatus comprising a processor configured to cause the apparatus to at least:
determine billing data from a plurality of accounts of a single patient; and
generate a consolidated billing statement comprising the determined billing data from each of the plurality of accounts.

8. An apparatus according to claim 7, wherein the processor is configured to cause the apparatus to generate the consolidated billing statement at least in part by generating a consolidated billing statement comprising an itemization of each of the plurality of accounts and a respective outstanding charge for each of the plurality of accounts.

9. An apparatus according to claim 8, wherein the processor is configured to cause the apparatus to generate a consolidated billing statement comprising a payment stub section enabling a designation of at least one account from the plurality of accounts to which a remitted payment is to be applied.

10. An apparatus according to claim 7, wherein the processor is configured to cause the apparatus to generate the consolidated billing statement at least in part by generating a consolidated billing statement comprising a single balance determined by merging outstanding charges for each of the plurality of accounts.

11. An apparatus according to claim 7, wherein two or more of the plurality of accounts are each associated with a respective unique visit of the patient.

12. An apparatus according to claim 7, wherein two or more of the plurality of accounts are each associated with a respective unique healthcare provider.

13. An apparatus according to claim 7, further comprising a memory storing computer program code, wherein the memory and stored computer program code are configured, with the processor, to cause the apparatus to:
determine billing data from a plurality of accounts of a single patient; and
generate a consolidated billing statement comprising the determined billing data from each of the plurality of accounts.

14. A non-transitory computer-readable storage medium having computer-readable program code portions stored therein for preparing a customized billing statement regarding services performed by a healthcare provider, the computer-readable program code portions comprising:
a program code portion configured to determine billing data from a plurality of accounts of a single patient; and
a program code portion configured to generate a consolidated billing statement comprising the determined billing data from each of the plurality of accounts.

15. A non-transitory computer-readable storage medium according to claim 14, wherein the program code portion configured to generate the consolidated billing statement comprises program instructions configured to generate a consolidated billing statement comprising an itemization of each of the plurality of accounts and a respective outstanding charge for each of the plurality of accounts.

16. A non-transitory computer-readable storage medium according to claim 15, wherein the program code portion configured to generate the consolidated billing statement comprises program instructions configured to generate a consolidated billing statement comprising a payment stub section enabling a designation of at least one account from the plurality of accounts to which a remitted payment is to be applied.

17. A non-transitory computer-readable storage medium according to claim 14, wherein the program code portion configured to generate the consolidated billing statement comprises program instructions configured to generate a consolidated billing statement comprising a single balance determined by merging outstanding charges for each of the plurality of accounts.

18. A non-transitory computer-readable storage medium according to claim 14, wherein two or more of the plurality of accounts are each associated with a respective unique visit of the patient.

19. A non-transitory computer-readable storage medium according to claim 14, wherein two or more of the plurality of accounts are each associated with a respective unique healthcare provider.
